(19) United States
(12) Patent Application Publication
(10) Pub. No.: US 2013/0180960 A1
(43) Pub. Date: Jul. 18, 2013

(54) PULSED LASER DEPOSITION APPARATUS AND DEPOSITION METHOD USING SAME

(71) Applicant: Hyungson Ki, Ulsan (KR)

(72) Inventor: Hyungson Ki, Ulsan (KR)

(73) Assignee: UNIST ACADEMY-INDUSTRY RESEARCH CORPORATION, Ulsan (KR)

(21) Appl. No.: 13/810,023

(22) PCT Filed: Jul. 12, 2011
(86) PCT No.: PCT/KR11/05098

§ 371 Date: Mar. 20, 2013

(30) Foreign Application Priority Data
Jul. 15, 2010 (KR) 10-2010-0068617

(51) Int. Cl. B23K 26/34

(52) U.S. Cl. CPC B23K 26/345
USPC 219/76.14

(57) ABSTRACT

Disclosed is a pulsed laser deposition apparatus, including: a laser beam generating unit which generates a laser beam; a deposition object; a vacuum chamber, in which a plurality of types of deposition target materials to be deposited on the deposition object is arranged; a beam splitter which splits the laser beam generated by the laser beam generating unit into a plurality of laser beams corresponding to the deposition target materials; and lens units which are arranged to correspond to the respective deposition target materials, and which focus the laser beams, which are applied by being split by the beam splitter, onto the respective deposition target materials.

### TECHNICAL FIELD

The present invention relates to a pulsed laser deposition apparatus and a deposition method using the same, and more particularly, to a pulsed laser deposition apparatus that irradiates a plurality of laser beams on deposition target materials so that atomic vapor generated in the irradiation can be formed as a thin film having a predetermined thickness on a deposition object and a deposition method using the same.

### BACKGROUND ART

In general, pulsed laser deposition or laser ablation, whereby a thin film having a predetermined thickness is formed on a semiconductor substrate by using atomic vapor of a predetermined target material that is generated by irradiating a pulsed laser beam on the predetermined target material, among thin film deposition techniques for growing a thin film on a monocrystalline and amorphous substrate, is a thin film fabrication technique by using a physical method that is recently widely used.

A pulsed laser deposition apparatus used in the above-described pulsed laser deposition technique includes a laser beam generating unit for generating a laser beam having a wavelength of 100 to 400 nm as an energy source, a target driving unit for driving a target material, and an electric heater for attaching and fixing a substrate and for performing thermal treatment. The target driving unit and the electric heater among them are installed in a vacuum chamber. In this case, thin film growth using the pulsed laser deposition apparatus can be performed in a vacuum or in a reaction gas atmosphere of several hundreds of mTorr. For example, when the target material is an oxide material, oxygen can be used as a reaction gas, and when the target material is a metal and polymer material, argon (Ar) can be used as the reaction gas. In order to deposit the target material on the substrate by using the pulsed laser deposition technique, a laser beam with a high pulse energy having a wavelength in the range of a ultraviolet (UV) region is generally used as the energy source. The laser beam is focused onto the surface of the target material in the vacuum chamber by a focusing lens and a quartz window after being generated in the laser beam generating unit. In this case, the focused area of the surface of the target material is about several mm², and a high laser energy that is integrated in the narrow area allows the target material to be ablated and generates laser plumes that are atomic vapors in the form of atomic spray. Vaporized atoms fly on the substrate at a high speed of several km per hour. In this way, atoms that have reached the substrate form an atomic layer having the same composition as that of the target material that is maintained in a minimum bonding energy state, due to a chemical reaction on the surface of the substrate and a reaction with constituents of the substrate. In this case, when the substrate is exposed to the laser plumes for a predetermined amount of time, a thin film having a predetermined thickness can be grown on the substrate.

However, when deposition is performed on the substrate by using a pulsed laser deposition apparatus according to the related art and a multilayered thin film is formed using a plurality of target materials, laser beams are sequentially irradiated on the respective target materials so that it takes long time to perform deposition of the thin film on the substrate.

Furthermore, when a multilayered thin film is formed of the plurality of target materials, according to the related art, a driving unit for moving the respective target materials to the focus of the laser beam is required to irradiate laser beams on the target materials by using one laser beam generating unit. On the other hand, when the target materials are not moved to the focus of the laser beam, the driving unit is not necessary, and a plurality of laser beam generating units corresponding to the target materials needs to be provided. Thus, a high equipment installation cost is required.

Also, as when depositing diamond-like carbon (DLC) on a stainless steel substrate, when characteristics of the substrate and deposition materials are very different from each other, adhesion strength between two materials is lowered so that, after additional surface processing is performed, deposition using a pulsed laser deposition apparatus should be performed.

### DETAILED DESCRIPTION OF THE INVENTION

### Technical Problem

The present invention provides a pulsed laser deposition apparatus in which, when a thin film/coating is formed using a plurality of deposition target materials, the composition of the thin film or coating to be deposited may be changed with time with a low installation cost, and a deposition method using the same.

The present invention also provides a pulsed laser deposition apparatus in which deposition target materials having low mutual adhesion strength may be stably deposited on a deposition object, and a deposition method using the same.

### Technical Solution

According to an aspect of the present invention, there is provided a pulsed laser deposition apparatus including: a laser beam generating unit which generates a laser beam; a deposition object; a vacuum chamber, in which a plurality of types of deposition target materials to be deposited on the deposition object is arranged; a beam splitter which splits the laser beam generated by the laser beam generating unit into a plurality of laser beams corresponding to the deposition target materials; and lens units which are arranged to correspond to the respective deposition target materials, and which focus the laser beams, which are applied by being split by the beam splitter, onto the respective deposition target materials.

The pulsed laser deposition apparatus may further include: a plurality of variable attenuators which is disposed between the beam splitter and the respective lens units and controls outputs of the laser beams irradiated on the respective deposition target materials beam splitter; and a controller which controls the plurality of variable attenuators to control the outputs of the laser beams as time elapses.

The laser beam may be a picosecond laser beam.

The controller may control the variable attenuators so that constituent percentages of the plurality of types of deposition target materials vary according to a depth of a deposition layer formed of the deposition target materials deposited on the deposition object.

The plurality of types of deposition target materials may include a first deposition target material and a second deposition target material, and the plurality of variable attenuators may include a first variable attenuator corresponding to the first deposition target material and a second variable attenuator corresponding to the second deposition target material, and the controller may control the outputs of the laser beams to increase gradually by using the first variable attenuator and may control the outputs of the laser beams to decrease gradually by using the second variable attenuator.

According to another aspect of the present invention, there is provided a deposition method using a pulsed laser deposition apparatus, the deposition method including: arranging a deposition object and a plurality of types of deposition target materials to be deposited on the deposition object in a vacuum chamber; generating a laser beam by using a laser beam generating unit; splitting the laser beam generated by the laser beam generating unit into a number of laser beams corresponding to a number of the deposition target materials by means of a beam splitter and outputting the laser beams; controlling a plurality of variable attenuators installed to correspond to a number of the deposition target materials and focusing the laser beams onto the respective deposition target materials in such a manner that the outputs of the laser beams, which are applied by being split by the beam splitter, vary by means of the variable attenuators installed to a number of the deposition target materials as time elapses; and depositing atomic vapors generated from the respective deposition target materials by focusing the laser beams, on a surface of the deposition object.

The focusing of the laser beams may include controlling the variable attenuators so that constituent percentages of the plurality of types of deposition target materials vary according to a depth of a deposition layer formed of the deposition target materials deposited on the deposition object.

The deposition object may be stainless steel, and the deposition target materials may include graphite and diamond-like carbon (DLC), and the outputs of the laser beams irradiated on the graphite may be controlled to decrease gradually by means of the variable attenuators as time elapses, and the outputs of the laser beams irradiated on the DLC may be controlled to increase gradually by means of the variable attenuators as time elapses.

In the generation of the laser beam, the laser beam may be a picosecond laser beam.

### Effect of the Invention

In a pulsed laser deposition apparatus according to the present invention, in a state where a plurality of types of deposition target materials are arranged in a vacuum chamber, a laser beam generated by a laser beam generating unit is split into a plurality of laser beams corresponding to the deposition target materials, and then, the laser beams are focused onto the respective deposition target materials by lens units. Thus, the deposition target materials are simultaneously ablated so that it doesn't take long to form a multilayered thin film on a deposition object and an installation cost can be reduced.

Also, in a deposition method using the pulsed laser deposition apparatus according to the present invention, in a state where a plurality of types of deposition target materials are arranged in a vacuum chamber, a laser beam generated by a laser beam generating unit is split into the number of beams corresponding to the number of the deposition target materials by means of a beam splitter, and then, the laser beams are focused onto the respective deposition target materials in such a manner that the outputs of the laser beams vary by means of variable attenuators as time elapses. Thus, a deposition layer that is formed when atomic vapors generated from the deposition target materials are deposited on the deposition object, is formed as a graded layer in which constituent percentages of the plurality of types of deposition target materials vary according to depth, so that the deposition target materials having low mutual adhesion strength can be stably deposited on the deposition object.

### DESCRIPTION OF THE DRAWINGS

FIG. 1 is a schematic view of a structure of a pulsed laser deposition apparatus according to an embodiment of the present invention;

FIG. 2 is a graph showing a variation of outputs of laser beams irradiated on a first deposition target material and a second deposition target material illustrated in FIG. 1;

FIG. 3 is a cross-sectional view of a structure of a deposition layer deposited on a deposition object according to the variation of the outputs of the laser beams illustrated in FIG. 2; and

FIG. 4 is a flowchart illustrating a deposition method using the pulsed laser deposition apparatus of FIG. 1, according to an embodiment of the present invention.

### BEST MODE OF THE INVENTION

Hereinafter, a method for manufacturing a pipe according to the present invention will be described in detail by explaining embodiments of the invention with reference to the attached drawings.

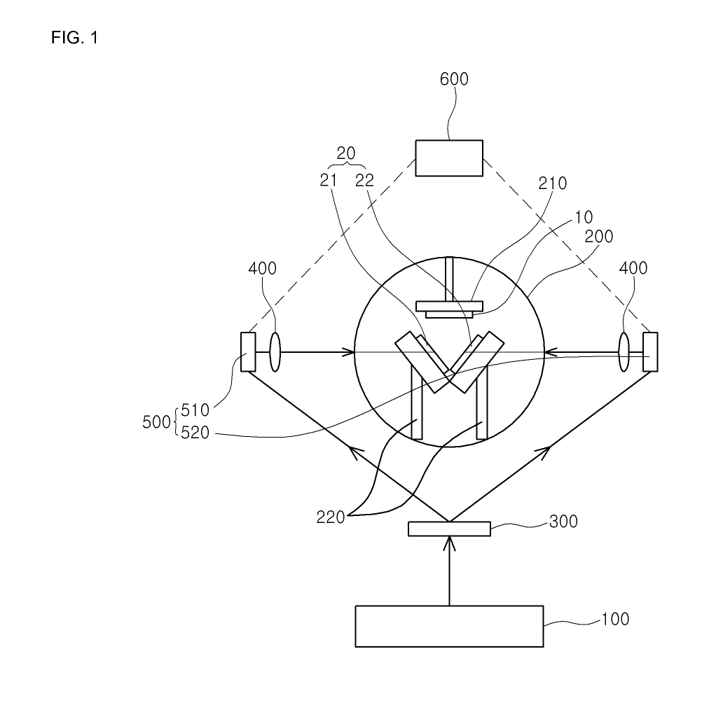

FIG. 1 is a schematic view of a structure of a pulsed laser deposition apparatus according to an embodiment of the present invention. Referring to FIG. 1, the pulsed laser deposition apparatus includes a laser generating unit 100, a vacuum chamber 200, a beam splitter 300, and lens units 400.

The laser generating unit 100 ablates a deposition target material 20 to be deposited on a deposition object 10 and generates a laser beam that causes atomic vapor in the form of atomic spray in the deposition target material 20. Here, the laser beam generated by the laser generating unit 100 is a picosecond laser beam having a high pulse repetition rate in the range of a pulse width of about 10 ps. However, aspects of the present invention are not limited thereto, and a nanosecond laser beam or a femtosecond laser beam may be generated.

The vacuum chamber 200 is a space in which atomic vapor is generated from the deposition target material 20 by irradiating the laser beam generated by the laser beam generating unit 100 and the generated atomic vapor is deposited on the deposition object 10. The deposition object 10 and the deposition target material 20 are disposed in the vacuum chamber 200. In this case, a first deposition target material 21 and a second deposition target material 22 that are included in the deposition target material 20 and that are different types of materials, are arranged in the vacuum chamber 200; however, aspects of the present invention are not limited thereto, and the deposition target material 20 including three or more different types of materials may be arranged in the vacuum chamber 200.

Fixing bars 210 and 220 that may fix the deposition object 10 and the deposition target material 20 stably in the vacuum chamber 200 may be installed in the vacuum chamber 200. In this case, the fixing bars 210 and 220 that fix the deposition target material 20 may be installed with the number of fixing bars corresponding to the number of the deposition target materials 20. Also, a driving unit (not shown) for driving the fixing bar 220 by rotation so as to rotate the deposition target material 20 and an electric heater (not shown) for thermal treatment of the deposition target material 20 may be disposed in the vacuum chamber 200.

The beam splitter 300 splits the laser beam generated by the laser generating unit 100 so that the laser beam can be irradiated on each of the plurality of types of deposition target material 20. That is, the beam splitter 300 is connected to the laser generating unit 100, receives the laser beam generated by the laser beam generating unit 100 and then splits the laser beam into a plurality of laser beams corresponding to the deposition target materials 20.

The lens units 400 focus the laser beams split by the beam splitter 300 onto the respective deposition target materials 20. A plurality of lens units 400 corresponding to the number of the deposition target materials 20 is installed. Here, the plurality of lens units 400 use a focusing lens in which the laser beams split by the beam splitter 300 are focused onto the respective deposition target materials 20. Furthermore, a quartz window (not shown) may be disposed on the lens units 400 so as to precisely irradiate the laser beams on the deposition target materials 20 by reducing the sizes of the laser beams.

The pulsed laser deposition apparatus illustrated in FIG. 1 may further include a variable attenuator 500 that is disposed between the beam splitter 300 and the lens units 400. The variable attenuator 500 controls outputs of the laser beams irradiated on the deposition target materials 20 by using the lens units 400. Here, the variable attenuator 500 of FIG. 1 includes a first variable attenuator 510 corresponding to the first deposition target material 21 and a second variable attenuator 520 corresponding to the second deposition target material 22. However, aspects of the present invention are not limited thereto, and the number of variable attenuators 500 corresponding to the number of the deposition target materials 20 may be installed

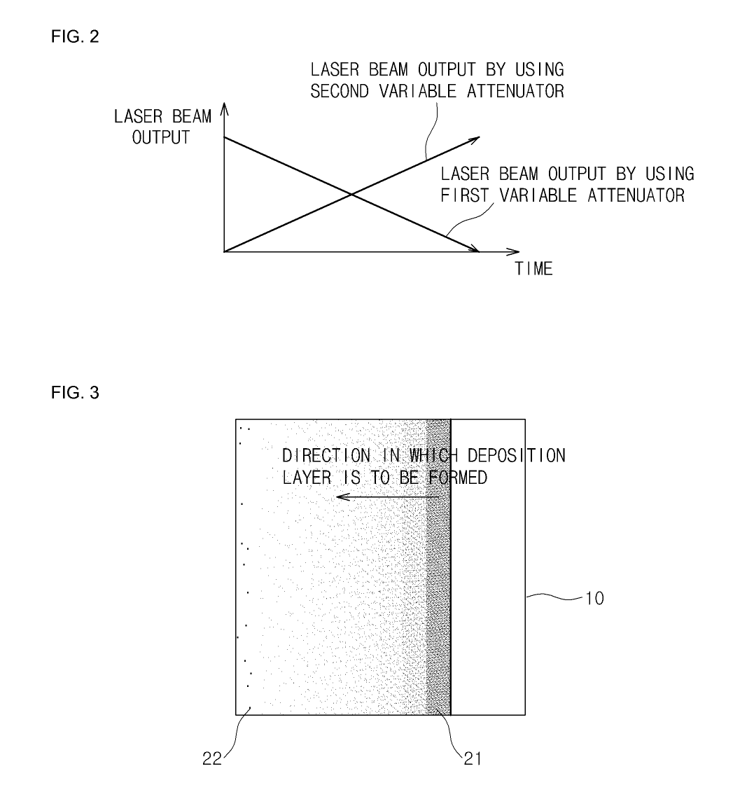

Also, the pulsed laser deposition apparatus of FIG. 1 may further include a controller 600 that is connected to the variable attenuators 500 and controls the variable attenuators 500. The controller 600 controls outputs of the laser beams by using the variable attenuators 500 as time elapses. Referring to FIG. 2, the first variable attenuator 510 controls the outputs of the laser beams to increase gradually by using the controller 600, and the second variable attenuator 520 controls the outputs of the laser beams to decrease gradually by using the controller 600. Thus, as the outputs of the laser beams irradiated on the respective deposition target materials 20 vary by using the controller 600 as time elapses, constituent percentages of the plurality of types of deposition target materials 20 vary according to the depth of a deposition layer formed of the deposition target materials 20 deposited on the deposition object 10. That is, as illustrated in FIG. 3, deposition from a state where the constituent ratio of the second deposition target material 22 ablated by the second variable attenuator 520 from the surface of the deposition object 10 is high to a state where the constituent ratio of the first deposition target material 21 ablated by the first variable attenuator 510 increases gradually, is performed.

Here, while the outputs of the laser beams irradiated on the deposition target materials 20 vary by controlling the variable attenuators 500 using the controller 600 as time elapses, the constituent percentages of the plurality of types of deposition target materials 20 vary according to the depth of the deposition layer formed of the deposition target materials 20 deposited on the deposition object 10. Thus, the deposition target materials 20 having low mutual adhesion strength may be stably deposited on the deposition object 10.

In this way, the pulsed laser deposition apparatus of FIG. 1, in a state where the plurality of types of deposition target materials 20 are arranged in the vacuum chamber 200, the laser beam generated by the laser beam generating unit 100 is split into the number of laser beams corresponding to the number of the deposition target materials 20 by using the beam splitter 300 and then, the laser beams are focused onto the deposition target materials 20 by using the lens units 400. Thus, the deposition target materials 20 are simultaneously ablated so that it doesn't take long to form a multilayered thin film on the deposition object 10 and an installation cost may be reduced.

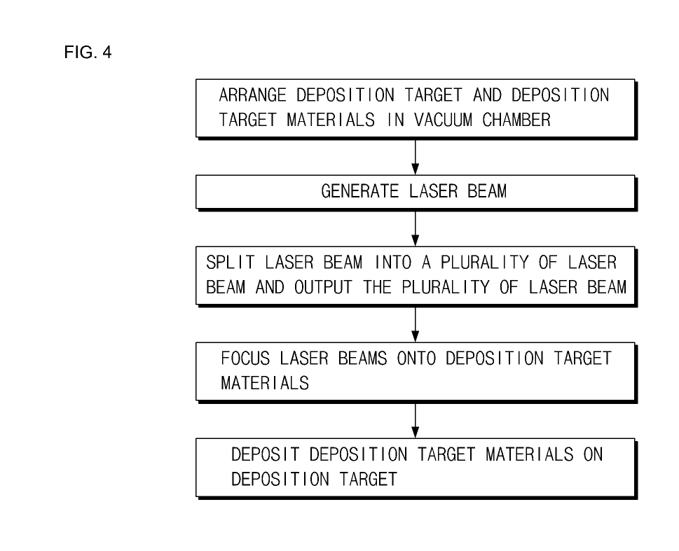

Hereinafter, a deposition method using the pulsed laser deposition apparatus of FIG. 1, according to an embodiment of the preset invention will be described in detail with reference to FIG. 4.

FIG. 4 is a flowchart illustrating a deposition method using the pulsed laser deposition apparatus of FIG. 1, according to an embodiment of the present invention. Referring to FIG. 4, the deposition method using the pulsed laser deposition apparatus of FIG. 1 includes: arranging a deposition object and a plurality of types of deposition target materials in a vacuum chamber; generating a laser beam; splitting the laser beam into a plurality of laser beams and outputting the plurality of laser beams; focusing the laser beams onto the plurality of types of deposition target materials; and depositing the deposition target materials on the deposition object.

First, the deposition object 10 and the deposition target materials 20 are fixedly arranged in the vacuum chamber 200. In this case, a plurality of different types of the deposition target materials 20 are arranged in the vacuum chamber 200 so as to form a thin film as a graded layer on the deposition object 10. That is, as previously described in FIG. 1, ceramics as the first deposition target material 21 and metal as the second deposition target material 22 are arranged in the vacuum chamber 200. However, the first deposition target material 21 and the second deposition target material 22 are not limited thereto.

In this manner, when the deposition object 10 and the plurality of types of deposition target materials 20 are arranged in the vacuum chamber 200, a laser beam to ablate the deposition target materials 20 is generated by the laser beam generating unit 100. In this case, the laser beam generating unit 100 generates a picosecond laser beam having a high pulse repetition rate.

Subsequently, the laser beam generated by the laser beam generating unit 100 passes through the beam splitter 300 and is split into a plurality of laser beams corresponding to the number of the deposition target materials 20, and the plurality of laser beams are output.

In this way, the respective laser beams split by the beam splitter 300 pass through a plurality of variable attenuators 500 installed to correspond to the number of the deposition target materials 20 and are focused onto the deposition target materials 20 by the lens units 400 in a state where outputs of the laser beams vary by means of the variable attenuators 500 as time elapses. That is, as illustrated in FIG. 2, while the respective variable attenuators 500 are controlled by the controller 600, the output of the plurality of laser beams split by the beam splitter 300 increase gradually or decreases gradually as time elapses, and the laser beams are focused onto the respective deposition target materials 20. In this way, by controlling the variable attenuators 500, amounts of atomic vapors generated when amounts of ablation of the deposition target materials 20 vary as time elapses, vary. Thus, as illustrated in FIG. 3, the constituent percentages of the plurality of types of deposition target materials 20 vary according to the depth of the deposition layer formed on the deposition object 10.

In this manner, when the laser beams are focused onto the respective deposition target materials 20 by the lens units 400 in a state where the outputs of the laser beams vary by means of the variable attenuators 500 as time elapses, atomic vapors are generated in the deposition target materials 20, and the generated atomic vapors are deposited on the surface of the deposition object 10. In this case, as described above, while the outputs of the laser beams irradiated on the respective deposition target materials 20 vary by means of the variable attenuators 500 as time elapses, amounts of atomic vapors generated in the respective deposition target materials 20 vary as time elapses. Thus, as illustrated in FIG. 3, the deposition layer is deposited on the deposition object 10 so that the constituent percentages of the plurality of types of deposition target materials 20 vary according to the depth of the deposition layer deposited on the deposition object 10.

By using the deposition method of FIG. 4, deposition of diamond-like carbon (DLC) may be performed on a stainless steel substrate as the deposition object 10. Adhesion of DLC is not well performed on the deposition object 10 that is the stainless steel substrate by using general pulsed laser deposition. On the other hand, when graphite and DLC are used as the deposition target materials 20, deposition of the DLC is stably performed on the deposition object 10. That is, graphite of the deposition target materials 20 is controlled so that the outputs of the irradiated laser beams decrease gradually by means of the variable attenuators 500 as time elapses, and DLC is controlled so that the outputs of the irradiated laser beams increase gradually by means of the variable attenuators 500 as time elapses. Thus, DLC may be deposited on the stainless steel substrate as the deposition object 10 with high adhesion strength.

In this way, the deposition method using the pulsed laser deposition apparatus of FIG. 1, in a state where the plurality of types of deposition target materials 20 is arranged in the vacuum chamber 200, the laser beam generated by the laser beam generating unit 100 is split into a plurality of laser beams corresponding to the number of the deposition target materials 20 by the beam splitter 300, and then, the laser beams are focused onto the deposition target materials 20 in a state where the outputs of the irradiated laser beams vary by means of the variable attenuators 500 as time elapses. Thus, the deposition layer formed when the atomic vapors generated from the deposition target materials 20 are deposited on the deposition object 10, is formed as a graded layer in which constituent percentages of the plurality of types of deposition target materials 20 vary according to depth so that the deposition target materials 20 having low mutual adhesion strength can be stably deposited on the deposition object 10.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A pulsed laser deposition apparatus comprising:
a laser beam generating unit which generates a laser beam;
a deposition object;
a vacuum chamber, in which a plurality of types of deposition target materials to be deposited on the deposition object is arranged;
a beam splitter which splits the laser beam generated by the laser beam generating unit into a plurality of laser beams corresponding to the deposition target materials; and
lens units which are arranged to correspond to the respective deposition target materials, and which focus the laser beams, which are applied by being split by the beam splitter, onto the respective deposition target materials.

2. The pulsed laser deposition apparatus of claim 1, further comprising:
a plurality of variable attenuators which is disposed between the beam splitter and the respective lens units and controls outputs of the laser beams irradiated on the respective deposition target materials beam splitter; and
a controller which controls the plurality of variable attenuators to control the outputs of the laser beams as time elapses.

3. The pulsed laser deposition apparatus of claim 1, wherein the laser beam is a picosecond laser beam.

4. The pulsed laser deposition apparatus of claim 1,
wherein the controller controls the variable attenuators so that constituent percentages of the plurality of types of deposition target materials vary according to a depth of a deposition layer formed of the deposition target materials deposited on the deposition object.

5. The pulsed laser deposition apparatus of claim 4, wherein the plurality of types of deposition target materials comprises a first deposition target material and a second deposition target material, and
the plurality of variable attenuators comprises a first variable attenuator corresponding to the first deposition target material and a second variable attenuator corresponding to the second deposition target material, and
the controller controls the outputs of the laser beams to increase gradually by using the first variable attenuator and controls the outputs of the laser beams to decrease gradually by using the second variable attenuator.

6. A deposition method using a pulsed laser deposition apparatus, the deposition method comprising:
arranging a deposition object and a plurality of types of deposition target materials to be deposited on the deposition object in a vacuum chamber;
generating a laser beam by using a laser beam generating unit;
splitting the laser beam generated by the laser beam generating unit into a number of laser beams corresponding to a number of the deposition target materials by means of a beam splitter and outputting the laser beams;
controlling a plurality of variable attenuators installed to correspond to a number of the deposition target materials and focusing the laser beams onto the respective deposition target materials in such a manner that the outputs of the laser beams, which are applied by being split by the beam splitter, vary by means of the variable attenuators installed to a number of the deposition target materials as time elapses; and
depositing atomic vapors generated in the respective deposition target materials by focusing the laser beams, on a surface of the deposition object.

7. The deposition method of claim 6, wherein the focusing of the laser beams comprises controlling the variable attenuators so that constituent percentages of the plurality of types of deposition target materials vary according to a depth of a deposition layer formed of the deposition target materials deposited on the deposition object.

8. The deposition method of claim 7, wherein the deposition object is stainless steel, and the deposition target materials comprise graphite and diamond-like carbon (DLC), and the outputs of the laser beams irradiated on the graphite are controlled to decrease gradually by means of the variable attenuators as time elapses, and the outputs of the laser beams irradiated on the DLC are controlled to increase gradually by means of the variable attenuators as time elapses.

9. The deposition method of claim 6, wherein, in the generating of the laser beam, the laser beam in is a picosecond laser beam.
